(19) United States
(12) Patent Application Publication
(10) Pub. No.: US 2010/0068683 A1
(43) Pub. Date: Mar. 18, 2010

(54) DEVICES AND METHODS FOR IMPROVING READING SKILLS

(75) Inventors: DONALD J. PANEC, Novato, CA (US); BRUCE GRANVILLE JOHNSON, Webster, NH (US)

Correspondence Address: Dascenzo Intellectual Property Law, P.C., 522 SW 5th Ave, Suite 925, Portland, OR, 97204-2126, US

(73) Assignee: Treasure Bay, Inc., Novato, CA (US)

(21) Appl. No.: 12/559,788

(22) Filed: Sep. 15, 2009

Related U.S. Application Data
(60) Provisional application No. 61/097,366, filed on Sep. 16, 2008.

(51) Int. Cl. G09B 17/00

(52) U.S. Cl. 434/178

(57) ABSTRACT

Phonics-based devices and methods for improving reading skills. The reading improvement devices and methods may incorporate a book or other text-containing media that includes an initial activity-based phonics portion that is designed to teach a less experienced reader about an aspect of phonics. The activity is designed to promote interaction by the less experienced reader with a parent or other more experienced reader to complete the activity portion. This initial activity portion is followed by a story portion that includes text selected to emphasize the phonics skills from the activity portion. The reading of the story portion may be performed collaboratively by the readers. The more experienced reader may provide additional instruction to emphasize the teachings of the initial activity portion. The reading improvement device may include a third portion, which may contain additional instruction about the phonics skills from the activity portion.

### RELATED APPLICATION

This application claims priority to similarly entitled U.S. provisional patent application Ser. No. 61/097,366, which was filed on Sep. 16, 2008 and the disclosure of which is hereby incorporated by reference.

### FIELD OF THE DISCLOSURE

The present disclosure is directed generally to devices and methods for improving reading skills, and more particularly to devices and methods for interactive use between readers of different reading skills, such as a parent and a child.

### BACKGROUND OF THE DISCLOSURE

An important aspect of teaching children to read is for them to develop an appreciation for reading—in essence, a desire to read. If a child successfully develops print and phonological awareness as the child's verbal language develops, the child is likely to establish the foundations for being a skilled reader. Children who do not develop these skills often have difficulty learning to read, and from this often stems a lifelong dislike of reading.

Beyond print awareness and alphabetic knowledge, the development of initial phonics skills includes building an awareness of letters and words. Learning to read involves forming connections between graphemes and phonemes to correlate the spellings of words to their pronunciations and meanings. However, these core building blocks of learning to read may be difficult to instill in a child if the experience is not fun and enjoyable. This fun and enjoyment may be provided in a variety of methods, including positive interaction by the child or other less experienced reader with a parent or other more experienced reader, initial success in learning new reading skills, and engaging in activities that introduce and/or enrich the development of these core skills.

### SUMMARY OF THE DISCLOSURE

The present disclosure is directed to devices and methods for improving reading skills, with an emphasis on phonics. Phonics generally relates to a method of teaching reading and spelling based on interpreting the letters in the word, with subsets of phonics focusing on phonemes (the sound of letters in words) and graphemes (the written form of letters in words). The reading improvement devices and methods may incorporate a book or other text-containing media that includes an initial activity-based phonics portion, or section, that is designed to teach a less experienced, often beginning, reader about an aspect of phonics. This initial portion contains at least one activity related to an aspect of phonics, such as graphemes, phonemes, allographs, and the like. The activity is designed to promote interaction by the less experienced reader with a parent or other more experienced reader. The less and more experienced readers interactively complete this initial activity portion. This initial activity portion is followed by a story portion that includes text selected to emphasize the phonics skills from the initial activity portion. The reading of the story portion may be performed in a variety of formats, or methods, including by the less experienced reader alone, by the less experienced reader and the more experienced reader together, by the more experienced reader followed by the less experienced reader, etc. The more experienced reader may provide additional instruction to emphasize the teachings of the initial activity portion. The book or other reading improvement device may include a third portion, which may contain additional instruction about the phonics aspect from the activity portion and/or be an enrichment portion relating to the prior or other phonics skills.

### BRIEF DESCRIPTION OF THE DRAWINGS

FIG. 1 is a schematic view of a reading improvement device according to the present disclosure.

FIG. 2 is a perspective view of a reading improvement device according to the present disclosure in the form of a book.

FIG. 3 is a schematic view of a reading improvement device according to the present disclosure in the form of a computer-implemented, or software-based, reading improvement device.

FIG. 4 depicts an illustrative, non-exclusive example of a section of an introduction portion that may be used with reading improvement devices and/or methods according to the present disclosure.

FIG. 5 depicts an illustrative, non-exclusive example of another section of an introduction portion that may be used with reading improvement devices and/or methods according to the present disclosure.

FIG. 6 depicts an illustrative, non-exclusive example of an activity, such as may be used in a pre-reading and/or enrichment portion of reading improvement devices and/or methods according to the present disclosure.

FIG. 7 depicts another illustrative, non-exclusive example of an activity, such as may be used in a pre-reading and/or enrichment portion of reading improvement devices and/or methods according to the present disclosure.

FIG. 8 depicts an illustrative, non-exclusive example of a section of a story portion that may be used with reading improvement devices and/or methods according to the present disclosure.

FIG. 9 depicts an illustrative, non-exclusive example of a section of a story portion that may be used with reading improvement devices and/or methods according to the present disclosure.

FIG. 10 depicts another illustrative, non-exclusive example of a section of a story portion that may be used with reading improvement devices and/or methods according to the present disclosure.

FIG. 11 depicts another illustrative, non-exclusive example of a section of a story portion that may be used with reading improvement devices and/or methods according to the present disclosure.

FIG. 12 depicts another illustrative, non-exclusive example of a portion of a story portion that may be used with reading improvement devices and/or methods according to the present disclosure.

FIG. 13 depicts another illustrative, non-exclusive example of an activity, such as may be used in a pre-reading and/or enrichment portion of reading improvement devices and/or methods according to the present disclosure.

### DETAILED DESCRIPTION AND BEST MODE OF THE DISCLOSURE

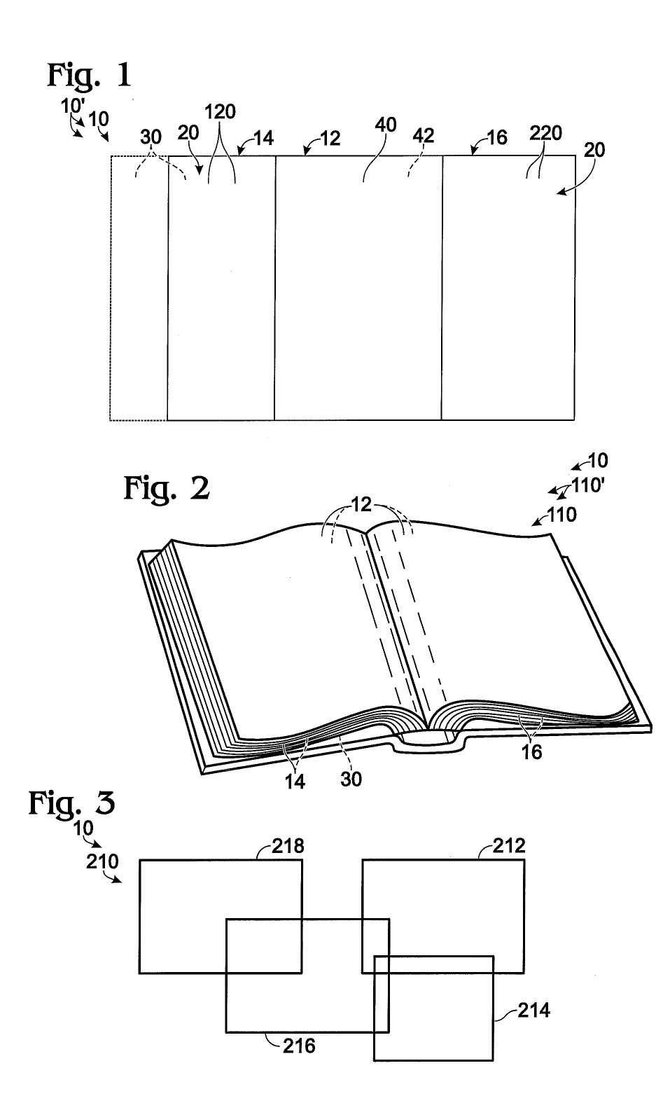

A reading improvement device according to the present disclosure is schematically illustrated in FIG. 1 at 10. Reading improvement device 10 includes a story portion 12, an activity portion 14, and an optional enrichment portion 16. Typically, the activity portion will precede the story portion, and the enrichment portion, when present, will follow the story portion, but this is not required to all embodiments. Activity portion 14 may additionally or alternatively be referred to as a pre-reading portion, and/or an instructional portion. Enrichment portion 16 may additionally or alternatively be referred to as a post-reading portion and/or a supplemental portion.

At least the activity portion 14 and the story portion 12 of a reading improvement device 10 according to the present disclosure are phonetically correlated, and it is within the scope of the present disclosure that the activity portion, the story portion, and the enrichment portion of a reading improvement device 10 are all phonetically correlated. By “phonetically correlated,” it is meant that the portions are designed to introduce and develop reading and awareness of the same phonics skills and/or phonetic elements. For example, the activity portion may introduce a series of phonetic elements and/or sight words, with the story portion including one or more stories that include the phonetic elements and/or sight words introduced in the activity portion. As illustrative, non-exclusive examples, these phonetic elements may include or relate to such phonetic elements as graphemes, phonemes, allographs, and the like. Sight words are frequently used words, or even high frequency words, that will tend to be recognized due to their frequent occurrence, as opposed to being phonetically decoded each time the word is read. Sight words may or may not be phonetically decodable words, or at least may or may not be intended to be phonetically decodable by a less skilled reader having the reading skill level intended for a less skilled reader using reading improvement device 10. As such, the awareness and recognition of sight words may be within the phonics skills to be emphasized in a particular activity even if the phonetic elements to be emphasized do not provide for the phonetic decoding of all of the sight words being emphasized.

The story portion may emphasize the particular phonetic elements and/or sight words introduced in the activity portion, such as by having these elements be present more than once, if not multiple times, in the story portion. Although not required in all reading improvement devices according to the present disclosure, the story portion often will include all of the phonetic elements and/or sight words introduced in the activity portion. The enrichment portion, when present, may be designed to further emphasize the phonetic elements and/or sight words introduced in the activity portion, such as to further increase awareness and comfort with the phonetic elements and/or sight words focused upon in the activity and story portions. It is also within the scope of the present disclosure that the enrichment portion, when present, is phonetically correlated with the story portion, but not the activity portion, and/or introduces new phonics skills, such as may be utilized and/or emphasized in another reading improvement device according to the present disclosure.

As discussed in more detail herein, reading improvement devices 10 according to the present disclosure are designed to be utilized together by a more experienced reader and a less experienced reader, who is often going to be a beginning reader. The age and relationship of the more and less experienced readers are not critical, but the more experienced reader will often be a parent of a child who is the less experienced reader. Other illustrative, non-exclusive examples of less experienced readers include adults who are still learning to read and/or individuals that are learning to read the particular language in which the reading improvement devices are written. Other illustrative, non-exclusive examples of more experienced readers include teachers, tutors, development specialists, guardians, relatives, and siblings (typically older siblings) of the less experienced reader with whom the more experienced reader is using a reading improvement device according to the present disclosure. The references herein to a less experienced reader and to a more experienced reader may additionally or alternatively be references to a lesser skilled reader and a more skilled reader, and/or to a reader at a lower reading skill level and a reader at a higher reading skill level.

In the schematically illustrated reading improvement device 10 of FIG. 1, it is graphically illustrated that activity portion 14 includes one or more activities 20 that are designed to be interactively completed by a more experienced reader and a less experienced reader. The activities are designed to introduce a series of phonics skills, such as particular phonetic elements and/or sight words, which will be present in the story portion 12 of the corresponding reading improvement device. Accordingly, when present in an activity portion 14, activities 20 may additionally or alternatively be referred to as introductory activities, before reading activities, pre-reading activities, and/or pre-reading phonics activities 120. The activities may be designed to develop the less experienced reader's familiarity and comprehension of the phonics skills introduced in the activity portion of a reading improvement device 10. The activities are designed to be fun and enjoyable for the less experienced reader, and thereby should stimulate the less experienced reader's interest in learning and using the phonics skills introduced in the activity portion, and thereafter proceeding to the story portion of the reading improvement device. Additionally, by presenting activities that are fun for the less experienced reader, the less experienced reader will have a desire to spend time on the activities and to actively participate in the activities, as opposed to perceiving the activities to be a task, or chore.

Some of the phonics skills presented in the activities of the activity portion may be familiar to the less experienced reader, while others may be new or less familiar. The inclusion of some familiar phonics skills may be helpful to increase the less experienced reader's sense of knowledge, comfort, and/or accomplishment, while the inclusion of some less familiar (or new) phonics skills will increase the less experienced reader's actual knowledge and repertoire of reading skills. Additionally, and perhaps especially in the case of less experienced or other developing readers, repetition of core reading skills, including phonics skills, may increase the less experienced reader's familiarity, comfort, and abilities with respect to these skills and thereby promote further increases in the less experienced reader's reading development.

Although not required to all activity portions 14 of reading improvement devices 10 according to the present disclosure, the activities may be designed to be relatively easy (but not simple) for a less experienced reader for which the reading improvement device is intended for use (i.e., having an appropriate reading skill level). In other words, the activities may be designed to introduce and teach the phonics skills at issue to the less experienced reader, but in a way that is enjoyable and leaves the less experienced reader with a sense of accomplishment. Therefore, “relatively easy” does not mean that the phonics skills must all be well-known to the less experienced reader. Instead, it suggests that the phonics skills introduced in the activity portion of a particular reading improvement device be designed to be appropriate for a less experienced reader of a particular reading skill level. In other words, the activities 20 in activity portion 14 may be designed to stimulate, rather than discourage, the less experienced reader's interest in learning the phonics skills and proceeding to the story portion. Because these phonics skills introduced in the activity portion will be present in the story portion, successful completion of the activity portion should promote the less experienced reader being successful in completing the story portion of the reading improvement device.

As discussed, the activities in activity portion 14 are designed to be completed interactively, or collaboratively, by the less experienced reader and the more experienced reader. The more experienced reader will assist the less experienced reader in learning the phonics skills presented in the activity portion, and thus will participate in the completion of the activities with the less experienced reader. This learning of the phonics skills may include learning to pronounce properly the phonemes and other phonetic elements, and the sight words. Although not required to all reading improvement devices according to the present disclosure, it may be desirable for the activities in the activity portion to not be “workbook” activities. By this it is meant that the activities are not intended to require the less experienced reader to write words, fill in blanks with corresponding text, or otherwise write on the activity portion in a manner that would inhibit use of the activity portion of a particular reading improvement device by another less experienced reader or by the same less experienced reader at a later date. Additionally, or alternatively, it is within the scope of the present disclosure that the activities in the activity portion do not require or otherwise provide for a user, such as the less experienced reader, to write on or otherwise damage or alter the activity portion of the reading improvement device. Accordingly, the same activity of a reading improvement device may be utilized many different times by the same or many different less experienced readers.

Reading improvement device 10 may further include an introduction portion 30. Although it is within the scope of the present disclosure that the introduction portion, when present, may be located and presented anywhere in the device, illustrative, non-exclusive examples of suitable placements include having the introduction portion precede the activity portion or be incorporated into the activity portion, as schematically illustrated in FIG. 1. Introduction portion 30 explains to a more experienced reader how to utilize the device, and especially the activity portion to improve the reading skills of the less experienced reader, typically in a collaborative and/or interactive manner. The introduction portion may further include tips and suggestions for the more experienced reader to utilize to assist the less experienced reader's use of the reading improvement device. These tips and suggestions may include information relating to how to use the activity portion, how to effectively assist the less experienced reader when the less experienced reader has trouble or appears to become frustrated, how to guide the less experienced reader in the various portions of the device, etc.

Story portion 12 includes one or more stories 40 to be read (at least initially) primarily by the less experienced reader. The one or more stories should include, and may emphasize and/or make repeated use of, the phonics skills introduced in the corresponding activity portion of the reading improvement device. The one or more stories may be on any desirable topic or topics, and may include fictional, non-fiction, and/or fact-based stories. The length of the story portion may vary within the scope of the present disclosure. As illustrative, non-exclusive examples, lengths of 10-35 pages may be used, with lengths of 15-30, and 20-25 pages being illustrative subsets of this range. The relative length of a particular story portion 40 in a reading improvement device 10 may vary based at least in part upon the reading skill level of the particular device and/or story portion, with story portions for devices 10 that are designed to be at a higher reading skill level having longer lengths than the corresponding story portions for devices 10 that are designed to be at a lower reading skill level. The length, number, and/or complexity of the corresponding activities of a particular device 10 also may (but are not required in all embodiments to) vary at least in part based upon the reading skill level of the device in which the activities are present.

While not required to all story portions 12 of a reading improvement device 10 according to the present disclosure, story portion 12 will typically include graphics 42 that relate to the text of the corresponding story. Graphics 42 may be in any suitable form, such as color drawings, monochrome drawings, cartoons, photographs, digital/computer-generated images, etc. Not only may graphics 42 increase the less experienced reader's interest in completing the story portion, such as may especially be the case with younger, less experienced readers, but the graphics may also assist the less experienced reader in recognizing and/or deciphering some of the words in the story. For example, a less experienced reader seeing an image of a bee, a car, a ball, a dog, etc. presented in conjunction with a story about such an object may more easily recognize the corresponding word. As this association is strengthened, the less experienced reader may be able to more quickly recognize, and thus read, the word. Expressed in slightly different terms, the story portion may include graphics that illustrate images of objects whose written spelling contains at least one of the phonetic elements introduced and/or emphasized in the activity portion. Graphics 42 may additionally or alternatively illustrate one or more sight words, such as which may have been introduced in the activity portion of the device.

As discussed, the phonics skills introduced in the activity portion may include phonetic elements and/or sight words. Similarly, the story portion will be written to emphasize the reading of words that contain the phonetic elements from the activity portion and/or the sight words from the activity portion. In the case of phonetic elements, the story portion will include phonetically decodable words that are level-appropriate for the less experienced reader for which the reading improvement device is intended for use. As discussed, the inclusion of associated graphics may also assist the less experienced reader in phonetically decoding these words.

When a story portion 12 includes more than one story 40, the stories may, but are not required to, be presented sequentially in order of increasing difficulty, or reading skill level. In such an embodiment, the less experienced reader's reading ability is gradually increased, or challenged, from one story to the next, with the intent being that the more experienced reader will determine when the less experienced reader is ready to proceed to the next story. Additionally or alternatively, this format may provide for the less experienced reader's success with a prior story encouraging or motivating the less experienced reader to proceed to the next story, which may be a more challenging story. It is also within the scope of the present disclosure that a story portion that includes more than one story 40 may include such stories that are at the same, or approximately the same, reading skill level or level of difficulty. In this latter embodiment, the series of stories 40 in a particular reading improvement device 10 may be designed to provide a series of opportunities for the less experienced reader to improve the reader's reading skills by collaboratively completing the stories with a more experienced reader, such as to learn and reinforce the phonics skills introduced in a corresponding activity 20.

Enrichment portion 16, when present, includes one or more additional activities 20 for interactive, and/or collaborative, completion by the more experienced reader and the less experienced reader. The activities 20 in enrichment portion 16 may be designed to reinforce the less experienced reader's comfort and familiarity with the phonics skills that were introduced in the corresponding activity portion and utilized in the corresponding story portion. Accordingly, activities 20 in enrichment portion 14 may additionally or alternatively be referred to as enrichment activities and/or post-reading activities 220. The enrichment portion may be phonetically correlated to the corresponding activity portion and/or story portion, such as by including one or more activities that utilize the phonics skills introduced in activity portion 14. However, it is also within the scope of the present disclosure that the enrichment portion may additionally or alternatively include one or more activities that are designed to introduce additional phonics skills, which may be related or unrelated to the phonics skills introduced in the corresponding activity portion. For example, it is within the scope of the present disclosure that a series of devices 10 may be designed to be used in incremental stages, or levels. In such an embodiment, the enrichment portion of one reading improvement device 10 also may introduce one or more phonics skills that will be emphasized, such as in the activity portion and/or story portion, of another reading improvement device 10 that is designed to be utilized by the less experienced reader after completion of the prior device.

The one or more post-reading activities 220 of the enrichment portion 16 of a reading improvement device 10 may be similar, at least in format, to the pre-reading activities 120 of the activity portion. However, because post-reading activities 220 are utilized after completion of the story portion, one or more of the post-reading activities may be designed to encourage interactive discussion between the less experienced reader and the more experienced reader, such as a discussion about the subject matter of the story portion. As may be appreciated, the one-on-one time between the more experienced reader and the less experienced reader, especially in the case of parent-child interaction, may be particularly rewarding and enjoyable and may provide a foundation for discussions that are not otherwise, or not as readily, initiated. Therefore, while the enrichment portion may include activities that are intended for interactive participation by the more experienced reader and the less experienced reader, it may also include discussion questions and/or topics, which may or may not relate to the subject matter and/or phonetic elements of the story portion.

It is within the scope of the present disclosure that one or more of the activities in the activity portion and/or enrichment portion of a reading improvement device 10 may be a game that is designed to emphasize one or more phonics skills and which is to be played by the less experienced reader with the more experienced reader. When implemented and/or presented to the less experienced reader as a game, as opposed to a task or chore, the less experienced reader's interest and enthusiasm may be greater.

Reading improvement device 10 may take any suitable form and/or structure and may present the content of the device's portions using any suitable media and visual presentation method. Illustrative, non-exclusive examples of suitable forms for reading improvement devices 10 include pre-printed media, such as books and magazines, and electronic media, such as computers (desktop, laptop, portable, hand-held, etc.), portable media players, electronic books (e-books), DVD players, and the like. When electronic and/or computerized media players are utilized, the activity, story, and (when present) enrichment portions may be stored in the volatile and/or non-volatile memory of the computer or player, contained in a removable cartridge or other removable memory device, downloaded/uploaded from another source, etc. It is within the scope of the present disclosure that the reading improvement device may be implemented as software and/or embodied in machine-readable media for presentation on a corresponding media player and/or display.

In FIG. 2, an illustrative, non-exclusive example of a reading improvement device 10 according to the present disclosure in the form of a book is schematically illustrated and generally indicated at 110. Book 110 includes the previously discussed phonetically correlated story portion 12, activity portion 14, an optional enrichment portion 16, and an optional introduction portion 30. Book 110 will typically include a hard or soft cover and will include a plurality of pages on which the portions of the device 10 are presented. Similarly, a series of books 110 may be provided, as schematically illustrated at 110′, to provide a series of reading improvement devices 10′, such as which may include books at different reading skill levels.

In FIG. 3, an illustrative, non-exclusive example of a reading improvement device 10 according to the present disclosure in the form of a software-based, or electronic, reading improvement device 210 is shown. Device 210 includes a display 212 on which the portions (activity, story, etc.) of the device are selectively displayed to users, such as the more experienced reader and the less experienced reader. Display 212 may include any suitable device for displaying at least the text and graphic content that otherwise would be displayed in print form in a printed, or book, form of a device 10. Illustrative, non-exclusive examples of suitable displays include computer monitors, televisions, display screens from a DVD-player or other media player, and the like. Such a device 210 will typically include at least one user-input device 214 through which inputs from the more experienced reader and/or the less experienced reader are communicated to a processor, or controller, 216 of the device. Illustrative, non-exclusive examples of such a user input device include a keyboard, mouse, touch screen, stylus, series of input buttons, and the like. These inputs may include such illustrative, non-exclusive commands as to transition to the next (or prior) screen (e.g., such as may correspond to the printed pages of a device 10 in the form of a book) or other set of images and text to be displayed, such as by transitioning between portions of an activity, between activities, from the pre-reading portion to the story portion, from the story portion to an enrichment portion (when present), etc. Additional illustrative, non-exclusive commands that may be inputted via a user input device include a command to cause the emission of sounds, such as the sounds of one or more words or phonetic elements, to cause instructions to be audibly generated, etc.

An electronic reading improvement device will also include software 218 that contains in machine-readable form the necessary programming to cause the electronic display of the portions (introduction, pre-reading, story, enrichment) of a device 10, including the corresponding text and graphics associated therewith. Software 218 may be present in any suitable form, such as stored in a memory portion of (or operatively associated with) the controller, or processor, 216, stored on a DVD, removable software module, or software cartridge, stored on a flash memory drive or other removable memory device, stored on and/or embodied in computer-readable media or a computer-readable memory device, stored on a remote computing device and then transmitted or downloaded for use by controller/processor 216, etc. Software 218 may, in some embodiments, be described as computer executable instructions.

The above-described general components of such an electronic reading improvement device 210 have been schematically illustrated in FIG. 3 in an overlapping arrangement to graphically represent that the components may be implemented together or separately so long as the components are suitably in communication (such as wired or wireless communication) with each other to display and provide for collaborative use of the device by the more experienced reader and the less experienced reader.

Although not separately depicted in the specific illustrative examples of devices 10 shown in FIGS. 2 and 3, it should be understood and is within the scope of the present disclosure that devices 110 and 210 may include any of the portions (introduction, pre-reading, story, and enrichment) discussed herein in connection with a more general device 10, including variants and options discussed, illustrated, and/or incorporated herein.

A reading improvement device 10 may be intended for use as a stand-alone, or independent, device for improving the reading skills of a less experienced reader. Additionally, or alternatively, a plurality of reading improvement devices 10 may be designed for use by a less experienced reader and/or a group of less experienced readers. For example, a series of reading improvement devices 10, as indicated schematically at 10′ in FIG. 1, may be designed for sequential use by a less experienced reader and/or use by a group of less experienced readers having different relative reading skill levels. For example, one or more of the reading improvement devices may be designed for use by a less experienced reader having a first, or lowest, reading skill level, with the activity, story, and enrichment portions of the one or more devices being appropriate for such a less experienced reader. Another one or more of the reading improvement devices 10 may be designed for use by a less experienced reader having a second reading skill level that is more advanced than the first reading skill level, and thus contains activity, story, and enrichment portions that are selected to be appropriate for a less experienced reader with the second reading skill level. The series of reading improvement devices 10′ may further include one or more devices that are designed for use by a less experienced reader having a third, a fourth, etc. successively increasing reading skill level. As the reading skill level for which a particular reading improvement device 10 is intended for use increases, so too may the complexity of the phonetic elements or other phonics skills, the number of syllables in the words in the story portion, the length of the sentences in the story portion, the number of words in the story portion, etc. increase. Similarly, the complexity of the activity and/or enrichment portions may similarly increase with the reading skill level of the reading improvement device, but this is not required to all embodiments.

A series of reading improvement devices 10 that includes more than one device 10 at each of the reading skill levels may permit two or more less experienced readers at the same reading skill level to use the series of devices simultaneously (and at the appropriate reading skill level) and/or permit a less experienced reader to utilize and enjoy several devices at the same reading skill level before being further challenged at the next reading skill level. Because the devices may be designed to not require the less experienced reader to write in the device, remove portions of the device, or otherwise render a portion of the device unfit for reuse, the devices may be reused by the same or different readers.

A series 10′ of reading improvement devices 10 according to the present disclosure may additionally or alternatively be referred to as a reading improvement kit that includes a plurality of reading improvement devices 10. The same applies to particular implementations of the reading improvement devices, such as a series and/or kit of reading improvement books, and a series and/or kit of reading improvement software, or software modules.

The following tables provide illustrative, non-exclusive examples of how a series 10′ of reading improvement devices 10 according to the present disclosure may be designed to support the development and learning of specific phonetic elements and sight words within a range of reading skill levels. Within each of the proposed reading skill levels, there may be a single reading improvement device 10 or a plurality of reading improvement devices 10. Similarly, a series 10′ of reading improvement devices 10 within the scope of the present disclosure may include one or more devices with a reading skill level that is more or less advanced than any of the illustrative, non-exclusive reading skill levels presented in the following tables. Similarly, it is within the scope of the present disclosure that a series or kit of such reading improvement devices may not include a device 10 at one or more of the reading skill levels presented in the following tables.

TABLE 1
Phonics Scope and Sequence Chart

| | Phonics, letters, | High frequency | Word | | |
|---|---|---|---|---|---|
| | and letter | words and sight | families | Pre-Reading | Enrichment |
| Level | sequences added | words added | added | Activities | Activities |
| 1 | m, a, t, h, p, n, | a, is, the, an, are, | at, ab, ad, | trace letters | rhyming-simple |
| | c, d, s, i, b, r, f | and, am, to, too, | am, ast, id, | letter hunt | rhyming-taking a trip |
| | short a, short i | down, can, no, | and, an, ip, it | tic-tac-toe | I spy - |
| | | do, there, where, | | letter bingo | first sound game |
| | | that, be, see, go, | | making | blending- |
| | | good, stop, so, | | words | guess the word |
| | | this | | phonics sight | segmenting- |
| | | | | word game | head, waist, toe |
| 2 | g, o, x, u, z, l, e, y, w, | in, he, I, on, was, | ack, ag, all, | trace letters | rhyming-I am thinking |
| | ar, ck, ea, wh | make, makes, by, | ar, ig, ill, ed, | letter hunt | first sound-taking trip |
| | short o, short u, | my, who, with, to, | ell, en, end, | tic-tac-toe | first sound- |
| | short e | does, for, what, | ent, et, est, | letter bingo | I am thinking |
| | | yes, puts, have, | od, ock, og, | making | I spy - first letter |
| | | said, she, get, | op, ut, us, | words | sound game |
| | | gets, wants | up, ust, un | phonics sight | segmenting- |
| | | | | word game | first I heard |
| 3 | k, j | gives, me, pulls, | ank, er, ish, | trace letters | rhyming-stand up |
| | er, ir, ur | after, first, new, | ake, ade, | letter hunt | final sounds- |
| | sh, th, ch, tch | old, of, put, old, | age, ail, | tic-tac-toe | taking a trip |
| | ge, gi, ce | put, were, her, my, | ain, ate, | letter bingo | final sounds- |
| | long a (a, a_e) | out, one, would, | ame, ait, | making | I am thinking |
| | long i (i, i_e) | will, work, you, do, | ide, ike, | words | blending-in sentences |
| | | here, start, | ice, ite, ive | phonics sight | segmenting- |
| | | started, like | | word game | say it, move it |
| | | | | | letter hunt |
| | | | | | alphabet soup |
| | | | | | letter bingo |
| | | | | | silly sentences |
| 4 | v, q, c, l, ng, dge | from, sees, went, | oke, ole, | trace letters | rhyming-wrong |
| | long o (o, o_e) | made, play, five, | ope, ue, eat, | letter hunt | rhymes |
| | s as /z/ sound | four, three, two, | ean, eal, | tic-tac-toe | mid sounds- |
| | long u (u, u_e) | into, see, think, | eed, een, | letter bingo | I am thinking |
| | long e(e, e_e, ea, ee) | both, wish, ride, | eep, eet, | making | mid sounds- |
| | er, ir, ur, or | asked, how, | ear, -y, ie, | words | taking a trip |
| | long vowels plus r | your, truly | ay, igh, | phonics sight | blending-in sentences |
| | long e (ey, ie) | | ight, ing, | word game | segmenting- |
| | long a (ai, ay) | | ang, ong, | | head, waist, toe |
| | long i (igh, y, ie) | | ung | | |
| | long o (oe, ow, oa) | | | | |
| | ed and es endings | | | | |
| 5 | long o (oa, oe) | they, want, we, go, | ue, oom, | trace letters | rhyming-I am thinking |
| | long u (ew, ue) | white, little, laugh, | oon | letter hunt | blending-turtle talk |
| | /ou/ (ou, ow) | now, been, could, | | tic-tac-toe | blending-taking a trip |
| | /o/ (aw, au) | laughed, live, | | letter bingo | segmenting- |
| | /oo/ as in book | very, worked, | | making | count sound |
| | /oo/ as in cool | over, doing, | | words | segmenting- |
| | /oi/ (oi, oy) | around, eating, | | phonics sight | head, waist, toe |
| | kn, wr, ph, mb | look, saw, some | | word game | |
| | le endings | | | | |

TABLE 2
Phonics Scope and Sequence Chart

| | Phonics, letters, | High frequency | Word | | |
|---|---|---|---|---|---|
| | and letter | words and sight | families | Pre-Reading | Enrichment |
| Level | sequences added | words added | added | Activities | Activities |
| 1 | m, a, t, h, p, n, | a, I, is, the, and, | at, ab, ad, | simple phonics | guess the word |
| | c, d, s, i, b, r, f | am, to, too, can, | am, ast, and, | sight word | rhyming game |
| | (stress short a) | down, no, there, | an, ass, as, | game | taking a trip |
| | (stress short i) | where, that, be, | ap, id, ip, it, | word bingo | rhyming game |
| | | see, good, he, | im, in, ib, if | make a face | head, waist, toes |
| | | go, stops, so, for, | | say the word | I spy first |
| | | this, has, his, my, | | tic-tac-toe | sound game |
| | | put, went, now, | | alphabet soup | |
| | | big | | | |
| 2 | g, o, x, u, z, l, e, y, w, | an, are, make, | ack, ag, all, | simple phonics | I am thinking |
| | j, k, v, ar, ck, wh | makes, with, | ar, ig, ill, ed, | sight word | rhyming game |
| | (stress short o) | have, get, gets, | ell, en, end, | game | I spy first letter |
| | (stress short u) | of, oh, in, she, on, | ent, et, est, | word bingo | sound game |
| | (stress short e) | was, by, who, | od, ock, og, | make a face | taking a trip |
| | (y as consonant) | what, yes, | op, ut, us, up, | making words | first letter |
| | s as /z/ sound | said, want | ust, un | picture walk | sound game |
| 3 | q, er, ir, ur | gives, me, pulls, | er, ir, ur, ish, | simple phonics | guess the word |
| | sh, th, ch, tch | after, first, like, | ake, ade, | sight word | letter hunt |
| | long a (a, a_e) | new, old, were, | ate, ame, | game | alphabet soup |
| | long i (i, i_e) | he, out, will, into, | ide, ike, ite, | word bingo | letter bingo |
| | | would, work, | ive | make a face | silly sentences |
| | | you, do, does, | | alphabet soup | |
| | | here, one, start, | | picture walk | |
| | | started, like | | making words | |
| 4 | or, ce, ge, ci, gi | from, made, | or, | simple phonics | guess the word |
| | (soft c, g) | play, five, four, | ace, ice, | sight word | letter hunt |
| | dge | three, two, think, | udge, edge, | game | alphabet soup |
| | long o (o, o_e) | both, wish, how, | oke, ole, ope, | word bingo | letter bingo |
| | long u (u, u_e) | asked, away, | use, ute, | make a face | silly sentences |
| | long e(e, e_e, ea, ee) | your, truly, ride, | eat, ean, eal, | alphabet soup | |
| | | each, most | eed, | picture walk | |
| | | | een, eep, eet | making words | |
| 5 | long a (ai, ay) | they, we, white, | ail, ain, ait, | simple phonics | guess the word |
| | long i (igh, y, ie) | little, been, | ay, igh, ight, | sight word | letter hunt |
| | ng | could, laugh, | y, ie, ang, ing, | game | alphabet soup |
| | er endings | laughed, live, | ong, ung | word bingo | letter bingo |
| | ing endings | very, doing, | | make a face | silly sentences |
| | possible ed | over, around, | | alphabet soup | |
| | endings | look, saw, some | | picture walk | |
| | | | | making words | |
| 6 | long e (ey, ie, y) | blue, come, find, | ey, ie, y, | simple phonics | guess the word |
| | long o (oa, oe, ow) | funny, yellow, | oad, oal, | sight word | silly sentences |
| | long u (ew, ue) | brown, many, | oam, oat, oe, | game | hop, hopscotch |
| | es endings | please, pretty, | ow, ew, ue | word bingo | lilly pads |
| | ed endings | say, our, soon, | | picture walk | rhyming poems |
| | | worked | | making words | |
| 7 | /ou/ (ou, ow) | again, every, fly, | oud, out, ow, | simple phonics | guess the word |
| | /o/ (aw, au) | any, give, going, | aw, aut, | sight word | silly sentences |
| | /oo/ as in book | know, once, | ood, ook, | game | hop, hopscotch |
| | /oo/ as in cool | open, round, | ool, oom, | go fish | lilly pads |
| | /oi/ (oi, oy) | thank, about, | oon, oot, oil, | picture walk | rhyming poems |
| | | | oy | making words | |
| 8 | long vowels plus | people, mother, | air, ear, | simple phonics | guess the word |
| | r, kn, wr, mb | because, only, | able, ible | sight word | silly sentences |
| | possible ph | should, whose, | | game | hop, hopscotch |
| | possible le endings | before | | go fish | lilly pads |
| | | | | picture walk | rhyming poems |
| | | | | making words | |

The following tables provide illustrative, non-exclusive examples of suggested content for a series of reading improvement devices 10, such as a series of books or software modules, having first through fifth and first through eighth reading skill levels, respectively. The following and preceding tables have been provided for the purpose of illustration, and not limitation. Reading improvement devices 10 including other phonics skills, subject matter, and/or characteristics are within the scope of the present disclosure, as provided for herein.

TABLE 3
Phonics Books Additional Guidelines

| | | # of words | | Length of Sentences/ |
|---|---|---|---|---|
| Level | # of words total | per page | Syllables | Sentences per page |
| Level 1 | 60 to 80 | 2 to 5 | 1 syllable words mostly or | Max - 5 words |
| | | | only | per sentence |
| | | | | Max - 1 sentence |
| | | | | per page |
| Level 2 | 90 to 110 | 3 to 6 | 1 syllable words mostly or | Max - 6 words |
| | | | only | Almost all 1 sentence |
| | | | | per page |
| Level 3 | 120 to 140 | 4 to 8 | 1 syllable words mostly | Max - 7 words |
| | | | Max of a couple | per sentence |
| | | | 2 syllable words | A few pages with 2 |
| | | | | sentences |
| Level 4 | 150 to 170 | 5 to 10 | 1 syllable words mostly | Max - 8 words |
| | | | some 2 syllable words | some pages with |
| | | | | 2 sentences |
| Level 5 | 180 to 200 | 6 to 12 | 1 syllable words | Max - 9 words |
| | | | with some 2-3 | per sentence |
| | | | syllable words | up to 2 sentences per |
| | | | | page |

TABLE 4
Phonics Books Additional Guidelines

| | | # of words | | Length of Sentences/ |
|---|---|---|---|---|
| Level | # of words total | per page | Syllables | Sentences per page |
| Level 1 | 60 to 90 | 2 to 5 | 1 syllable words mostly | Max - 5 words |
| | | | or only | per sentence |
| | | | | Max - 1 sentence |
| | | | | per page |
| Level 2 | 90 to 120 | 3 to 7 | 1 syllable words mostly | Max - 6 words |
| | | | or only | Almost all 1 sentence |
| | | | | per page |
| Level 3 | 120 to 150 | 4 to 10 | 1 syllable words mostly | Max - 7 words |
| | | | or only | A few pages with |
| | | | Max of a couple of 2 | 2 sentences |
| | | | syllable words | |
| Level 4 | 150 to 210 | 5 to 15 | 1 syllable words mostly | Max - 8 words |
| | | | some 2 syllable words | some pages with |
| | | | | 2 sentences |
| Level 5 | 210 to 270 | Max of 20 | Some 2 syllable words, | Max - 10 words |
| | | | optionally some 3 | Max 3 sentences |
| | | | syllable words with suffix | |
| Level 6 | 270-350 | Max of 25 | Some 2 syllable words | Max - 10 words |
| | | | Some 3 syllable words | Max 4 sentences |
| | | | with suffix | |
| Level 7 | 350-450 | Max of 30 | 1 and 2 syllable words | Max - 12 words |
| | | | Some 3 syllable words | No sentence limit |
| | | | with suffix | (some pages may be |
| | | | | only text) |
| Level 8 | 450-550 | Max of 35 | 1 & 2 syllable words | Max - 12 words |
| | | | Some 3 syllable words | No sentence limit |
| | | | | (some pages may be |
| | | | | only text) |

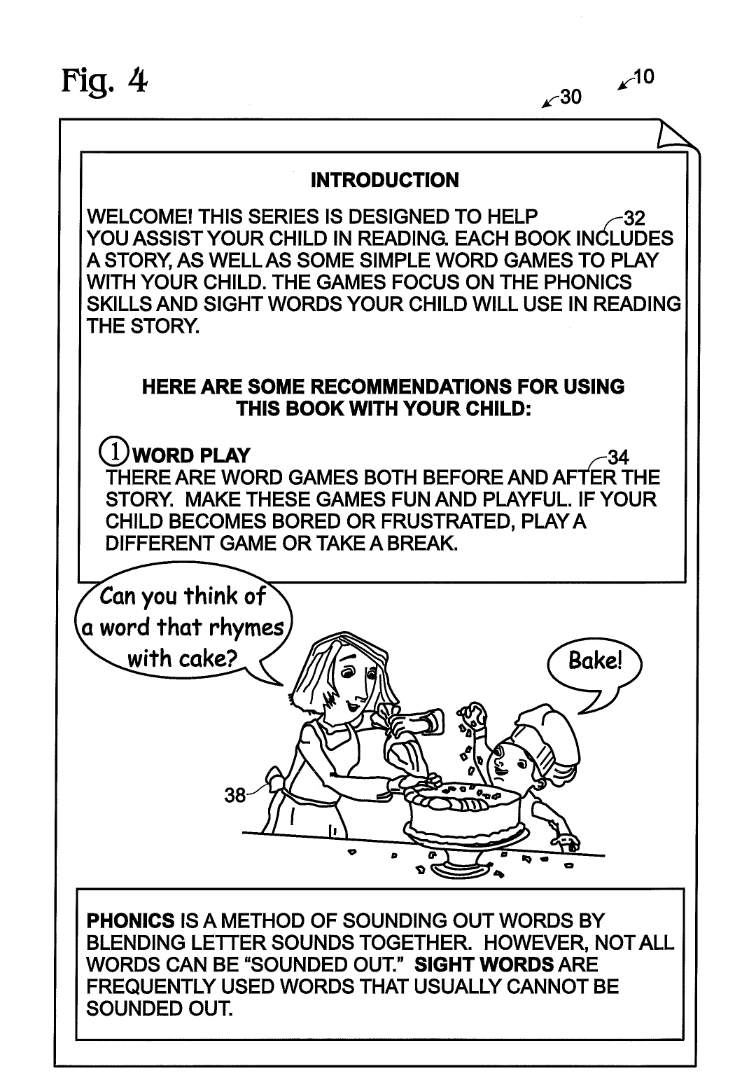

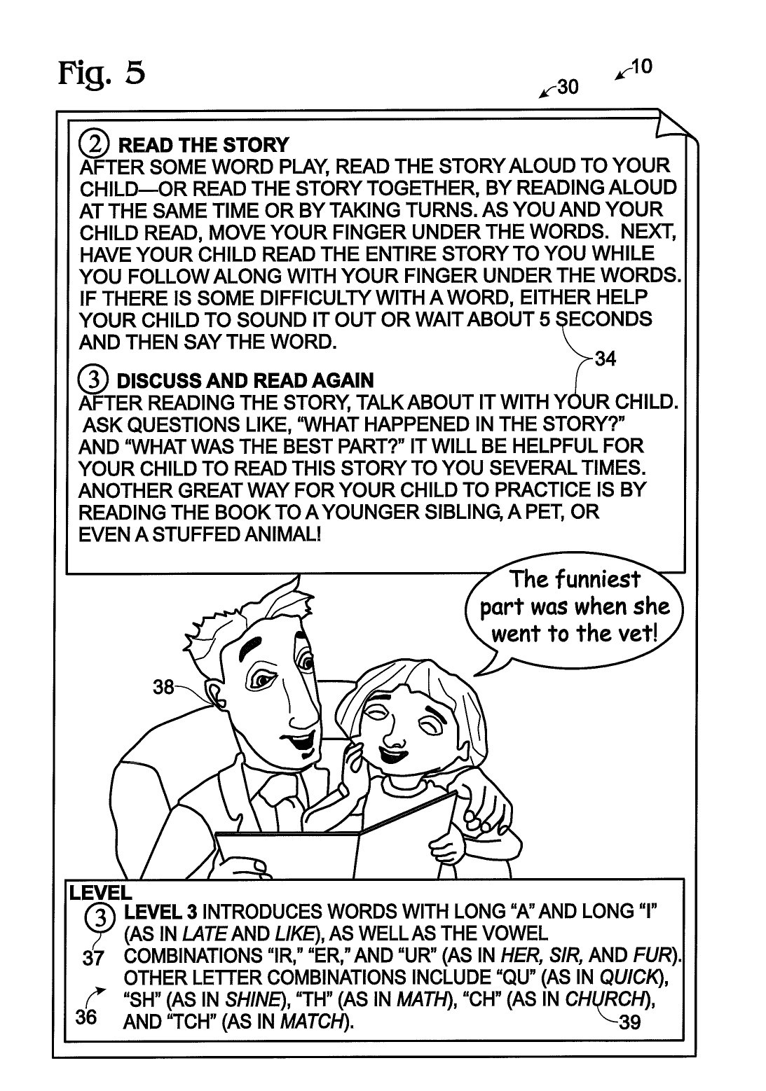

FIGS. 4 and 5 collectively provide an illustrative, non-exclusive example of an introduction portion 30 that may be used in and/or with reading improvement devices 10 and/or methods according to the present disclosure. As shown in FIGS. 4 and 5, the introduction portion may provide an explanation section 32 that explains to a more experienced reader how to utilize the reading improvement device, such as to explain the interaction of at least the activity portion and the story portion thereof. The illustrated example of an introduction portion also includes an optional recommendations section 34, which includes tips and suggestions, such as for the more experienced reader to utilize to assist the less experienced reader's use of the reading improvement device. As discussed, these tips and suggestions may include information relating to how to use the activity portion of device 10, how to effectively assist the less experienced reader when the less experienced reader has trouble or appears to become frustrated, how to guide the less experienced reader in the various portions of the reading improvement device, interactive activities for after the story portion is read, activities for the less experienced reader for after the story portion is read, etc.

The introduction portion shown in FIGS. 4 and 5 also includes an optional level indicator 36, which is presented in FIG. 5 and which indicates the relative degree of difficulty and/or reading skill level of the reading improvement device 10. The level indicator may be helpful when a particular reading improvement device 10 is part of a series, or kit, containing a plurality of reading improvement devices that are designed to have different reading skill levels.

For example, a more experienced reader, or even a less experienced reader, may use level indicator 36 (when present) to select an appropriate reading improvement device 10 for use. In the illustrative, non-exclusive example of a level indicator 36 shown in FIG. 5, the level indicator includes both an indicia 37 indicating the reading skill level of the device, as well as a description 39 of the phonics skills to be emphasized in the reading improvement device. As an additional illustrative, non-exclusive example, a level indicator 36 for a level 1 reading improvement device 10 may be “Level 1 focuses on simple words with short “a” and short “i” (as in cat and sit). Consonants used at this level include: b, c, d, f, h, m, n, p, r, s, and t.” As a further illustrative, non-exclusive example, a level indicator 36 for a level 2 reading improvement device may be “Level 2 introduces simple words with short “e,” short “o,” and short “u” (as in get, hot, and bug). All consonants are used at this level except “q.” Special sounds include “ck” (as in lock), “wh” (as in when), “ar” (as in car), and “s” as the “z” sounds (as in suds).” Additional illustrative, non-exclusive examples of suitable indicia and/or descriptions for a level indicator are presented in the previously presented tables.

Indicia 37 is depicted in FIG. 5 as a number that represents the relative reading skill level of the device within a range of numerical reading skill levels. It is within the scope of the present disclosure that indicia may take other forms that are suitable to indicate the relative reading skill level of the device. Illustrative, non-exclusive examples of other suitable indicia include a relative number of images (with the number of such images indicating the relative reading skill level of the device), words describing the relative reading skill level (i.e., beginner, medium, advanced, etc.), etc. It is within the scope of the present disclosure that a level indicator 36 may not include both indicia 37 and description 39.

Although not required, introduction portion 30 may also include graphics 38, such as to provide graphic illustrations of the textual content of the introduction portion and/or to visually present to the more experienced reader and the less experienced reader the message, or tone, of collaboration and working together that is a core component of devices 10. Because the less experienced reader will often have a relatively low reading skill level, as the less experienced reader will typically be a beginning reader, the graphics may be helpful to encourage the less experienced reader to use the reading improvement device. This may be particularly effective if the less experienced reader has not previously utilized a reading improvement device 10 and if the less experienced reader has been previously frustrated with prior attempts at being taught how to read.

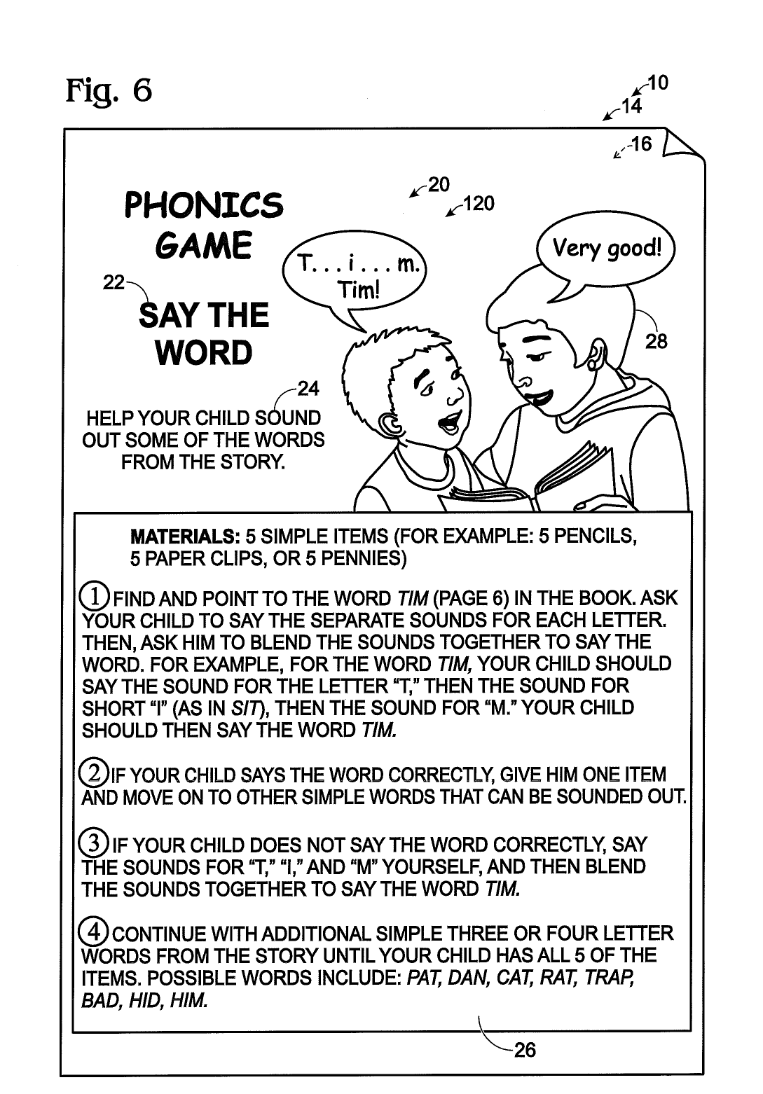

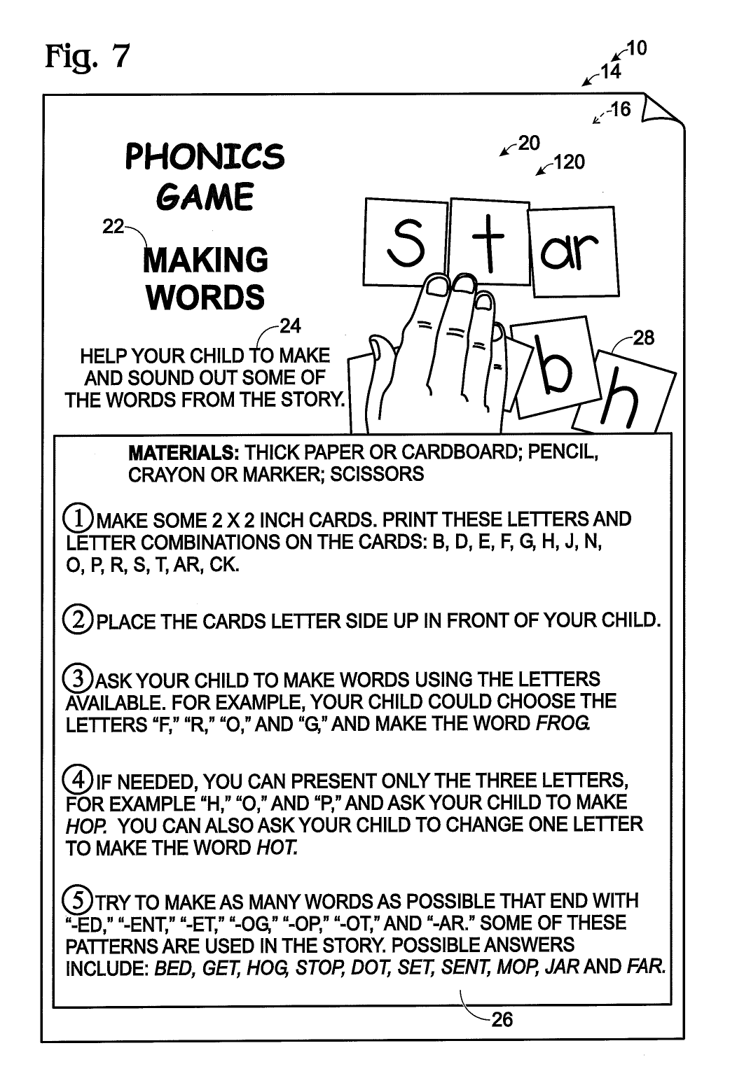

FIGS. 6 and 7 provide illustrative, non-exclusive examples of activities 20 that may be used in and/or with reading improvement devices 10 and/or methods according to the present disclosure. The activities 20 illustrated in FIGS. 6 and 7 are designated as pre-reading activities 120, such as may be presented in activity portion 14 of a reading improvement device 10. However, it is within the scope of the present disclosure that the activities may additionally or alternatively be utilized as a post-reading activity, such as in an enrichment portion of the device. This is schematically depicted in FIGS. 6 and 7 by the inclusion in dashed lines of reference numeral 16, which corresponds to an enrichment portion of a reading improvement device. In FIGS. 6 and 7, the more and less experienced readers are respectively referred to as a parent and a child to illustrate an expected use of a book, software module, or other reading improvement device 10 that includes the activities. As discussed, however, reading improvement devices and/or methods according to the present disclosure may be used with different more and/or less experienced readers.

FIG. 6 provides an example of the Say the Word activity suggested in Table 2 for use as a pre-reading activity 120 for a reading improvement device having a level 1 reading skill level. FIG. 7 provides an example of the Making Words activity suggested in Table 2 for use as a pre-reading activity 120 for a reading improvement device having a reading skill level of 2-8, with the illustrated example being selected to be at a level 2 reading skill level. The respective suggested uses of the activities are not a requirement or exclusive example, as other uses and/or relative reading levels may be utilized. For example, by increasing the complexity of the words and/or phonetic elements utilized in the activity of FIGS. 6 and 7, the activity may be designed to have a higher reading skill level. It follows then that reducing the complexity of the words and/or phonetic elements may also be utilized to reduce the reading skill level of the activity. During use of the reading improvement devices, such as the activities thereof, the more experienced reader may selectively increase or reduce the reading skill level of a particular activity depending upon how the less experienced reader is engaging with and/or performing with the original reading skill level of the activity. For example, if a less experienced reader appears to be struggling and/or otherwise having difficulty with the activity, a lower reading skill level may be appropriate. On the other hand, if the less experienced reader appears to be disinterested and/or does not appear to be challenged by the activity, then a higher reading skill level may be appropriate.

In FIGS. 6 and 7, both activities 20 include a title portion 22 that identifies the activity and thus may be used by the readers to recognize when the activity of a particular reading improvement device has a similar or identical format to an activity from a different reading improvement device 10. Even for a less skilled reader who cannot yet read the title portion, the reader still may recognize the words as sight words and/or be able to phonetically decode the words. When the less skilled reader recognizes the activity as being a fun activity that the reader recalls being enjoyable when last collaboratively completed with a more skilled reader, this should only further and proactively stimulate the less experienced reader's interest in interactively working with the more skilled reader to complete the activity. The activities 20 of FIGS. 6 and 7 both also include an optional goal portion 24, which presents to the more experienced reader the objective of the activity.

Activities 20 include an instructions portion 26, which explains to the more experienced reader how to interactively and collaboratively work with the less experienced reader to complete the activity. The instructions portion optionally may include suggestions and/or tips beyond the general instructions for completing the activity. As illustrative, non-exclusive examples, these instructions and/or tips may be designed to assist a more experienced reader with adjusting the reading skill level of the activity, for assisting a less skilled reader who is having difficulty with the activity, for expanding or adding onto the activity, etc.

Activities 20 also may include an optional graphics portion 28. Graphics portion 28 may illustrate graphically an aspect of the activity, including the use/play of the activity by the readers. Graphics portion 28 additionally or alternatively, and similar to the graphics portion of the introduction portion, may also visually depict a positive and interactive message to the readers.

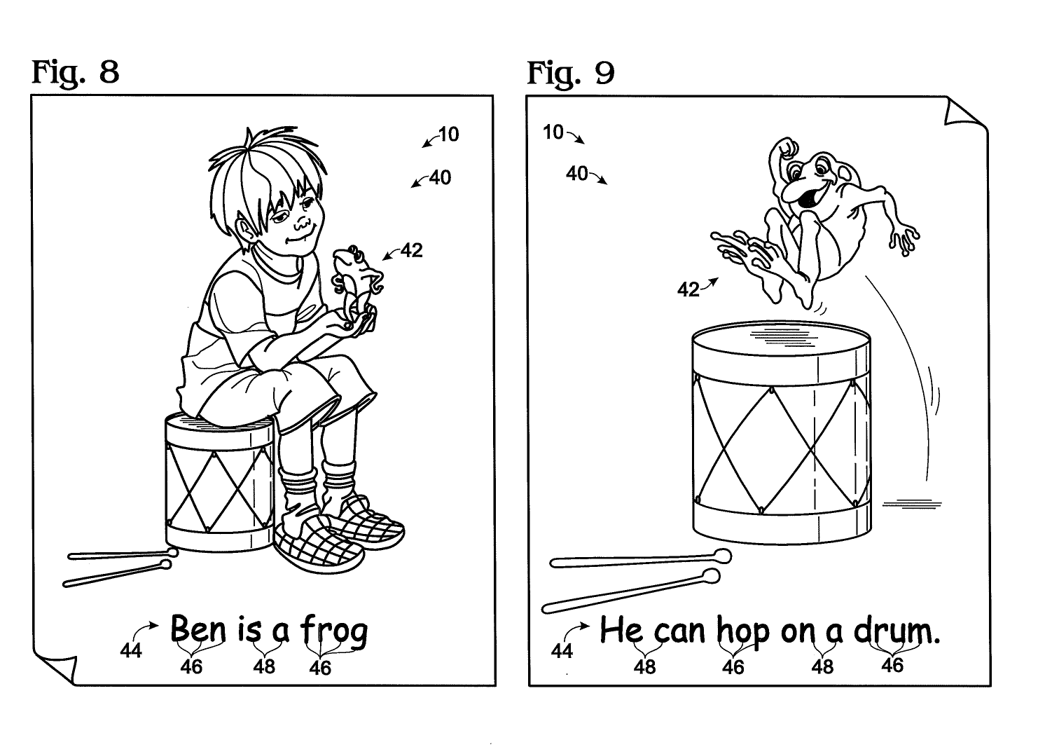

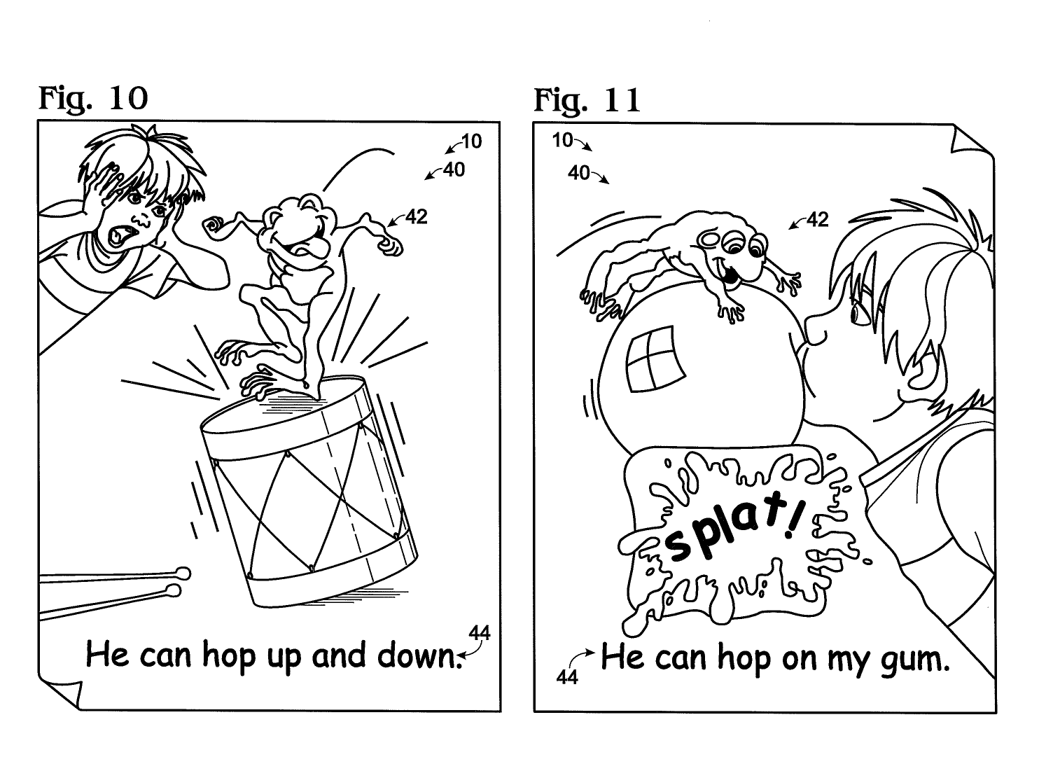

FIGS. 8-11 provide illustrative, non-exclusive examples of a section of a story portion 40 of a reading improvement device 10 and/or which may be utilized with reading improvement methods according to the present disclosure. The depicted examples represent a section from a story portion of a reading improvement device with a level 2 reading skill level. In a reading improvement device 10 in the form of a book, FIGS. 8-11 may be described as depicting pages from the book. In a reading improvement device 10 in the form of software, or a software module, FIGS. 8-11 may be described as depicting screens, or screen displays, of the software, or software module.

As discussed, story portion 40 includes both graphics 42, which may additionally or alternatively be referred to as a graphics region 42, and text 44, which also may be referred to as a text region 44. Text region 44 is designed to be sequentially presented in intervals appropriate for the designed reading skill level of device 10, and to include words that similarly are selected to be appropriate for the designed reading skill level of the device. The text region of story portion 40 should emphasize at least one, and typically, a plurality of, the phonics skills introduced in the activity, or activities, of a corresponding activity portion of the reading improvement device. As discussed, these phonics skills to be emphasized may include phonetic elements, and may include sight words. Representative, but not exclusive, examples of such phonetic elements are indicated at 46 in FIGS. 8-11, and representative, but not exclusive, examples of sight words are indicated at 48 in FIGS. 8-11. Graphics 42 should interrelate to the text of the story portion, and may include visual representations of one or more words and/or actions described in the text of the story portion. In some embodiments, the illustrated words and/or actions may also correspond to the phonics skills being emphasized in the story portion, thereby further reinforcing the phonics skills introduced in the activity portion.

In the particular example of a section of a story portion 40 shown in FIGS. 8-11, the text region emphasizes phonics skills introduced in the activity shown in FIG. 7. For example, the activity of FIG. 7 introduced phonetic elements relating to the short “o” sound, and the consonants “f,” “g,” “h,” “p,” and “r,” and the illustrated section of a story portion shown in FIGS. 8-11 emphasizes the words “frog” and “hop.” As shown, “hop” is presented in text region 44 several times in the illustrated section of a story portion, and both words also are illustrated graphically several times. Also presented in the text region of FIGS. 8-11 are a plurality of sight words, such as which may have been introduced in another activity from the activity portion of the corresponding reading improvement device and/or in another such activity or reading improvement device. For example, many of the sight words presented in FIGS. 8-11 are also presented in Tables 1 and 2.

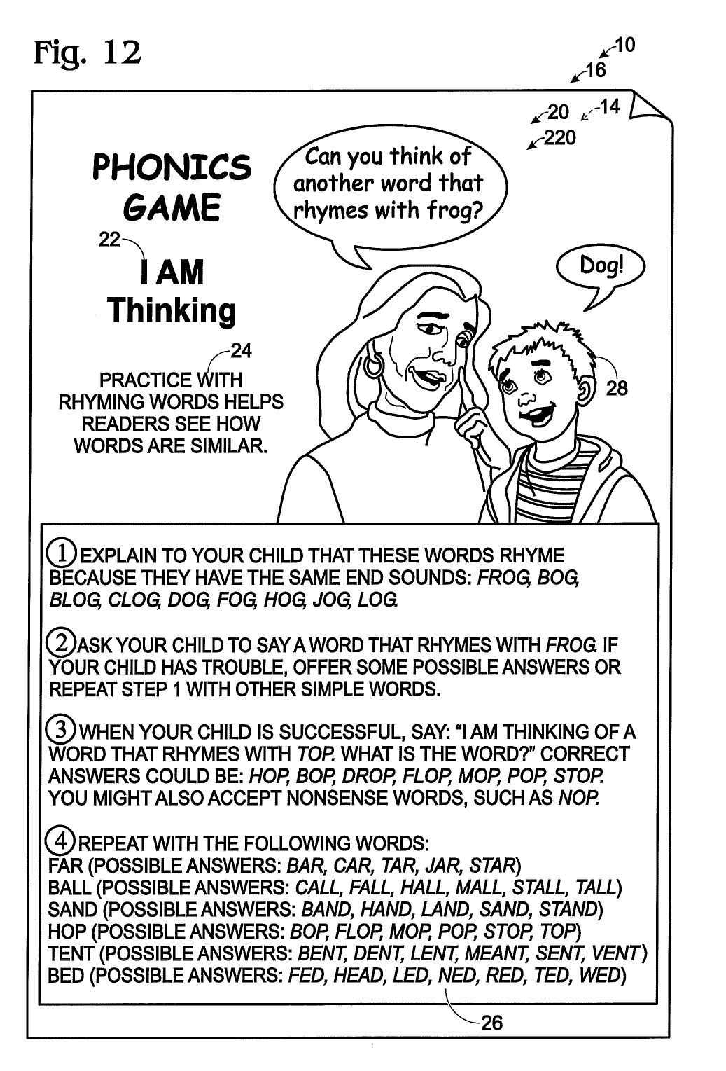

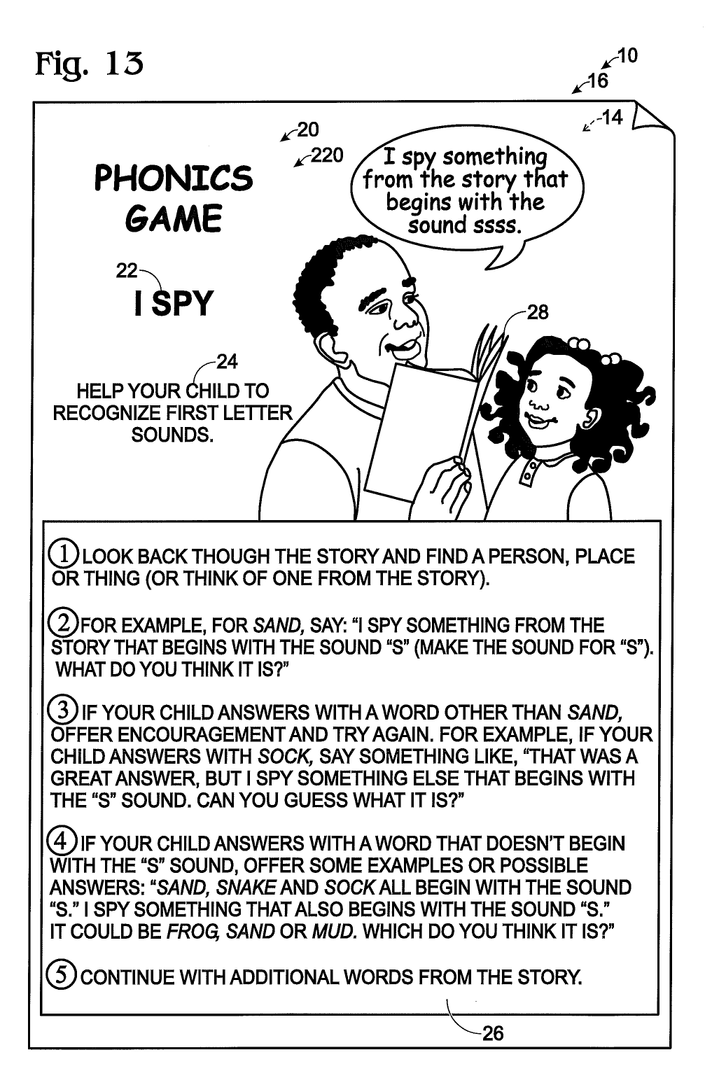

FIGS. 12 and 13 provide illustrative, non-exclusive examples of activities 20 that may be used in and/or with reading improvement devices 10 and/or methods according to the present disclosure. The activities 20 illustrated in FIGS. 12 and 13 are designated as post-reading activities 220, such as may be presented in an enrichment portion 16 of a reading improvement device 10. However, it is within the scope of the present disclosure that the activities may additionally or alternatively be utilized as a pre-reading activity, such as in an activity portion of the device. This is schematically depicted in FIGS. 12 and 13 by the inclusion in dashed lines of reference numeral 14, which corresponds to an activity portion of a reading improvement device 10. In FIGS. 12 and 13, and similar to FIGS. 6 and 7, the more and less experienced readers are respectively referred to as a parent and a child to illustrate an expected use of a book, software module, or other reading improvement device 10 that includes the activities. The activity 20 depicted in FIG. 12 corresponds to the I am Thinking activity that is suggested in Table 1 as being a suitable enrichment activity for reading improvement devices having a reading skill level of 2-5, and in Table 2 as being a suitable enrichment activity for reading improvement devices having a level 2 reading skill level. The activity depicted in FIG. 13 corresponds to the I Spy activity that is suggested in Tables 1 and 2 as being a suitable enrichment activity for reading improvement devices having a reading skill level of 1-2. As discussed in the context of FIGS. 6 and 7, the respective suggested uses of the activities are not a requirement or exclusive example, as other uses and/or relative reading levels may be utilized, and as the relative reading skill levels of the activities may be adjusted, such as by increasing or decreasing the complexity of the corresponding phonics skills incorporated into the activities. In further similarity to the activities 20 of FIGS. 6 and 7, the activities of FIGS. 11 and 12 include a title portion 22, an optional goal portion 24, an instructions portion 26, and an optional graphics portion 28. As discussed previously, activities 20 that are presented in an enrichment portion 16 of a reading improvement device may be phonetically correlated with the story portion 12 of the device, or even both the story portion and the activity portion of the device. The examples of activities shown in FIGS. 12 and 13 graphically demonstrate this relationship by emphasizing phonic skills that were introduced in the activity of FIG. 7 and the section of a story portion that is shown in FIGS. 8-11. Enrichment portion activities also may introduce new phonics skills and/or make be designed to promote discussions or other positive collaborative interactions between the less skilled reader and the more skilled reader.

Previously presented Tables 1 and 2 suggest additional examples of suitable activities, including proposed designations of the activities as being pre-reading or enrichment activities.

Descriptions of some of these proposed activities were presented herein in FIGS. 6-7 and 12-13. Descriptions of others of the activities have been incorporated by reference herein, while others are believed to be self-explanatory from the suggested title portions presented in the tables. For the purpose of completeness, and to provide additional illustrative examples of activities that may be utilized with reading improvement devices and/or methods according to the present disclosure, the following discussion is provided.

A Make a Face activity involves the more experienced reader selecting a word from the story portion of the reading improvement device. This word may be a sight word that is emphasized in the story portion and/or may contain one or more of the phonetic elements that are emphasized in the story portion. The more experienced reader draws a space for each of the letters in the selected word, and the less experienced reader guesses letters. If the less experienced reader correctly guesses a letter that is in the selected word, then the more experienced reader writes the letter on the corresponding space. If not, then the more experienced reader draws a portion of a face. The goal of the activity (at least from the perspective of the less experienced reader) is to complete the selected word before the more experienced reader draws the complete face (i.e., before the less experienced reader reaches the maximum number of incorrect guesses. A goal of the activity (perhaps from the perspective of the more experienced reader) is to have the less experienced reader practice saying the phonetic elements and/or otherwise utilize phonics skills, including increasing recognition of the overall word. As a variation of this activity, the more experienced reader may ask the less experienced reader to guess phonetic elements/sounds, as opposed to simply saying letters.

A Letter Hunt activity involves writing the letters of the alphabet, or a selected subset thereof, on separate pieces of paper. The writing of the letters may be performed by the more experienced reader, the less experienced reader, or collaboratively by both of the readers. The pieces of paper are placed by the more experienced reader around the room, house, or other location where the readers are using the reading improvement device, and then the less experienced reader hunts for the letters. The number of letters and/or difficulty with which the letters may be hidden may affect the difficulty of the activity. The less experienced reader may be asked to say/pronounce the letters when they are found, and the found letters may then be used by the readers to spell one or more words. During this latter aspect of the activity, the more experienced reader may work with the less experienced reader to sound out the letters, and corresponding phonetic elements and words. As a variant of this activity, phonetic elements may be written on the pieces of paper. As a further variant, the letters and/or phonetic elements may be written on objects other than pieces of paper. As still a further variant, the activity may utilize words, as opposed to individual letters, and in such an embodiment may be referred to as a Word Hunt activity.

A Silly Sentences activity may involve the more experienced reader reading, to the less experienced reader, a “silly sentence” containing repeated occurrences of a phonetic element, with the more experienced reader asking the less experienced reader to listen to the phonetic element. As an example, the phonetic element may be the sound of the first letter in an alliteration or similar series of similar first letter sounds. An illustrative, non-exclusive example of such a sentence is “Bobby bakes big biscuits for Billy Blue.” Other phonetic elements may be used, and the activity may emphasize one of the phonetic elements at the reading skill level of the reading improvement device and/or method with which the activity is presented and/or used. The more experienced reader may then ask the less experienced reader to complete a new silly sentence with a word that includes the same phonetic element, or even to suggest a word that includes a new phonetic element that is emphasized in the new sentence. For example, a sentence that emphasizes a new initial letter sound is “Fast fickle fish find famous funny _,” with possible answers including “fairies,” “fangs,” “fathers,” feathers,” “feasts,” and “fins.” The more experienced reader should be ready to offer possible answers to the less experienced reader, to repeat the phonetic element for the less experienced reader, to reiterate the less experienced reader's goal, etc. Even nonsense words may be acceptable, as the phonics-related goal of the activity is for the less experienced reader to identify and be able to use certain phonetic skills, which as discussed, may be initial letter sounds. The activity may be repeated with additional silly sentences that the more experienced reader creates. In time, some less experienced readers may be able to create, or at least attempt to create, their own silly sentences. Some less experienced readers may even then ask the more experienced reader to complete one of these silly sentences.

Another illustrative, non-exclusive example of a Silly Sentences activity involves the more experienced reader writing at least one sentence (which is not required to be a silly sentence) on a piece of paper and then cutting the piece of paper so that the individual words are on separate pieces of paper. The words are then mixed up, or jumbled, such as by shuffling or otherwise rearranging the pieces of paper. The less experienced reader, and/or both readers, then rearranges the words to reform the (or an) original sentence, and/or to create new sentences. This latter option is likely to result in sentences that at least the less experienced reader considers to be “silly sentences,” even if the original sentence was not a silly sentence. As the less experienced reader selects and/or arranges the words, the more experienced reader may encourage the less experienced reader to phonetically decode or otherwise read the words, and eventually the sentence. Using more than one original sentence may increase the range of options for the less experienced reader to make a wider variety of silly sentences.

An Alphabet Soup activity will typically involve creating a series of pieces of paper (typically of the same size) that each contains a letter. The pieces of paper are placed into a pile, into a container, into an actual cooking pot, or otherwise into a pretend pot of soup. In a first illustrative, non-exclusive example of such an activity, each player (such as the less experienced reader and the more experienced reader) begins with a letter from the series, and the remaining pieces of paper are placed in the “pot.” The readers take turns drawing letters from the “pot,” potentially even with a wooden spoon or ladle, and/or after stirring the “soup.” When a player can make a word by putting the player's letters together, the player does so and reads the word aloud. The game may continue so that each player has additional opportunities to make (and read) words using the player's letters. The initial series of letters may be selected to emphasize phonetic elements and/or to include high frequency letters. The initial series of letters may be identified in the instruction region of the activity, although the readers may select additional or alternative letters. In a variant of this activity, the pieces of paper may include phonetic elements, such as letter combinations that produce a particular phoneme or other sound. An illustrative, non-exclusive example of a series of letters and phonetic elements to be used for such an activity is “e, o, u, a, ar, ck, wh, g, b, s, c, k, j, l, t, m, p, n, f, r, w, and h.” In further variants of this activity, the players may start with two or more letters/phonetic elements. One or both of the players (i.e., the less experienced reader and/or the more experienced reader) may start with one or more of the phonetic elements to be emphasized in the activity.

In a further variant of an Alphabet Soup activity, two series of pieces of paper containing letters or phonetic elements are made, with each series spelling the same word or words, such as a word or series of words from the story portion of the corresponding reading improvement device. The letters are mixed up and placed into the “pot of soup.” The players take turns drawing from the pieces of paper in the pot, with each player trying to draw all of the letters to spell the preselected word or words. If a player draws a letter that the player does not need to spell the preselected word or words, the letter is returned to the “pot.” When a player completes the spelling of the preselected word or words, the player reads the word(s) out loud. Play may continue until the second player also draws sufficient letters to complete the spelling of the preselected word(s) and has an opportunity to read the word(s) out loud.

In still a further variant of an Alphabet Soup activity, the names of at least the more and less experienced readers are printed on separate colors of paper and/or in different colors. The names are cut so that the letters are all on individual pieces of paper, and the pieces of paper are placed into a pile, into a container, or otherwise into a pretend pot of soup. The readers take turns drawing letters from the “pot,” potentially even with a wooden spoon and/or after stirring the “soup.” If the letter matches a letter in the reader's name, then the reader keeps the letter. If not, the letter is returned to the “pot,” and the next reader draws a letter. This continues until one reader's name is complete, or until all readers have completed their names. The less experienced reader is encouraged to say the letters as they are drawn from the “pot.” In a Memory activity, a series of words (such as sight words and/or words containing the phonetic elements to be emphasized) are written on separate index cards or otherwise equally sized pieces of paper. Each word should be written on at least two separate cards. The less experienced reader should be encouraged to say the words as they are written (typically by the more experienced reader) on the cards, potentially after the more experienced reader also says the words and/or identifies one or more phonetic elements in the words. The cards are then placed face down on a playing surface, and the readers take turns sequentially turning over two cards. The reader says the word on the cards as they are turned over. If the words on the overturned cards match, then the reader keeps the match and takes another turn. If the words do not match, then the cards are returned to their original position with the words facing downward, and the next reader takes a turn. The cards may be saved for when the activity is repeated by the readers and/or for combination with others sets of cards, such as which may be produced when a similar activity is utilized with a different reading improvement device according to the present disclosure.

A Go Fish activity may be similar to the Memory activity discussed above, except that the readers are dealt a subset of the cards, and then the readers play a traditional “go fish” game using the cards, with the readers taking turns asking each other if they have a particular word on the asking reader's cards. If so, the other reader's card is given to the asking reader, who may place this set of cards on the playing surface as a “match.” If not, then the asking player draws another card from the cards that were not originally dealt to either of the readers.

Additional examples of card-based activities are Letter Bingo and Word Bingo. In Word Bingo, a series of words are written on cards, such as described above, except that the word only needs to appear on a single card. Bingo charts are then created by the readers, with the bingo charts containing a subset of the words for which cards were made. Typically, the bingo charts will contain a grid (3×3, 4×5, 5×5, etc.) of the words, but this is not required. The less skilled reader is encouraged to frequently phonetically decode and/or read the words, such as when the less skilled reader selects the words to be on a particular bingo chart. The cards are then shuffled, turned face-down, and sequentially drawn. The less experienced reader may be asked to read the words on the cards as they are drawn. If the word on a drawn card is present on a reader's bingo chart, then a coin or other marker is placed over the word on the chart. Play continues consistent with a suitable bingo format. Letter Bingo has the same format, except the cards contain individual letters instead of complete words. As a further variant, phonetic elements may be placed on the cards.

A Making Words activity includes making cards that contain letters and/or phonetic elements. The less experienced reader may be asked to say the letters and/or phonetic elements as the cards are made. The cards are then placed face-up in front of the less experienced reader (or both readers), and then the goal is to make words using the cards. In a variation of this activity, the more experienced reader may ask the less experienced reader to make words that begin with or end with a certain letter string, phonetic element, or series of phonetic elements. For example, the less experienced reader may be asked to make as many words that end with “-ave” by adding one or more of the letters and/or phonetic elements on the cards in front of “-ave.”

A Rhyming activity involves a more experienced reader asking the less experienced reader to say words that rhyme with a selected word. This step may be preceded by the more experienced reader explaining what it means for words to rhyme and/or by providing examples of words that rhyme. The more experienced reader also may offer suggestions, if necessary, to the less experienced reader if the less experienced reader is having trouble saying (thinking of) words that rhyme with the selected words. Even nonsense words still are productive, as they still will involve the less experienced reader placing a letter or phonetic element in front of the letter(s) and/or phonetic element(s) to be rhymed. For example, if the word to be rhymed is “ant,” answers may include “can't,” “pant,” “grant,” “rant,” and “chant.”

A Picture Walk activity typically is used with less experienced readers having a lower reading skill level and involves the readers looking at the story portion and discussing the graphics thereof. The more experienced reader may read sections of the story portion at this time. The more experienced reader may ask the child questions about the depicted images in the graphics and/or about the subject matter of any text section that is read. The questions may be designed to cause the less experienced reader to repeat sight words and/or words with phonetic elements to be emphasized. This discussion may include pointing to the words in the text region that correspond to the images being discussed.

A Guess the Word activity is another example of an activity that may be more appropriate for less experienced readers having a lower reading skill level. The activity includes the more experienced reader selecting a word from the story portion of the reading improvement device, and then saying the sounds (and/or phonetic elements) that make up the word. For example, if the word is “Pat,” the more experienced reader may say the sounds for the letter “p,” followed by short “a” (as in cat), followed by the letter “t,” with a pause between the sounds. The less experienced reader is asked to guess the word. Initially, this may involve the less experienced reader (or both readers) repeating the sounds, perhaps at the same or at a faster pace than when the more experienced reader originally made the sounds. The letters in the selected word may be pointed out as the word is sounded out. This activity may be repeated with other words from the story portion, words that rhyme with a successfully guessed word, or even with other words selected by the more experienced reader.

Illustrative, non-exclusive examples of methods for using a reading improvement device 10 according to the present disclosure have been discussed in the preceding discussion in which the devices themselves were introduced and discussed. Additional and/or alternative methods for using a reading improvement device 10 are presented in the following discussion. These methods also may be referred to as phonics-based reading improvement methods and/or as methods for improving the reading skills of a less experienced reader. Before proceeding to use a reading improvement device 10, a more experienced reader may elect to select a particular reading improvement device 10 from a series of such devices, such as to select a device that is believed to be at the appropriate reading skill level for the less experienced reader who will be using the device. If the appropriate reading skill level is not known to the more experienced reader, the more experienced reader may simply start at the first (or lowest reading skill level) device in the series. If only a single reading improvement device is present or available, then this initial selection step is moot.

Unless the more experienced reader is already familiar with the format and structure of the reading improvement devices, the more experienced reader should review introduction portion 30, if present. By reviewing the introduction portion before utilizing the reading improvement device with the less experienced reader, the more experienced reader may be able to more effectively guide the less experienced reader's use and enjoyment of the device. However, this preview of at least the introduction and/or activity portion of a reading improvement device 10 is not required.

The more and less experienced readers may then select and complete at least one activity 20 from an activity portion 14 of the reading improvement device. As discussed, these activities are designed to be interactive, collaborative activities that introduce and/or reinforce to the less experienced reader phonics skills that will be emphasized in the story portion of the reading improvement device. With knowledge of this purpose of the activities, the more experienced reader will assist the less experienced reader in pronouncing and recognizing the corresponding phonics skills. Also, as the less experienced reader may be apprehensive or frustrated by the new phonics skills, the more experienced reader should guide and assist the less experienced reader, as appropriate, especially with the activity portion and story portion.

As the less experienced reader becomes more familiar with the phonics skills, less assistance and/or support from the more experienced reader may be needed. However, because the activities are intended to be interactive and not entirely defined with predetermined “workbook-like” answers, repeated use of even the same reading improvement device by the same more experienced and less experienced readers may provide different outcomes and experiences. As discussed, the activity portion may include a single activity or two or more activities. When a plurality of activities is provided, the more experienced reader may guide the less experienced reader in the selection of the activities and/or the order in which the activities are completed. This selection may even include deciding to skip one or more of the activities because the more experienced reader decides that one or more of the activities are above the particular reading skill level (or particular interest/emotion level) of a less experienced reader at the time that the readers are using the device.

When the more and less experienced readers proceed to the story portion 12 of a reading improvement device, they may begin by browsing, rather than initially reading, the story to be read. This may include looking at the corresponding graphics and discussing what the corresponding story may be about. Where the graphics depict words that include the phonetic elements, sight words, or other phonics skills from the activity portion, the more experienced reader may assist the less experienced reader in pronouncing the words and/or recognizing the words within the story. This may even be an activity in the corresponding activity portion and/or enrichment portion. During use of the story portion of the device, the text of the story portion will be read aloud by the less experienced reader and/or the more experienced reader, with a goal being that the less experienced reader eventually reads the entire text region aloud without assistance from the more experienced reader.

Initially, and depending upon the reading skill level of the less experienced reader relative to the reading skill level of the reading improvement device, the more experienced reader may read an entire section of the story portion, or even the entire story portion, aloud to the less experienced reader. Should the more experienced reader initially read the entire text region to the less experienced reader, the more experienced reader may elect to point to particular words, such as sight words or words containing phonetic elements and/or sight words from the activity portion, as the words are read aloud by the more experienced reader. In this manner, the less experienced reader may learn to read words by associating the appearance or spelling of the words with the spoken sound of the words. Thereafter, the text region of the story portion may be reread with the less experienced reader reading aloud at least some of the text. In some situations, the less experienced reader may be able to read some or all of the story portion aloud right away, with the more experienced reader merely providing support and/or pronunciation assistance if needed. In some situations, the more and less experienced readers may take turns reading sections of the text region aloud, such as individual or alternating words, sentences, etc. In some situations, the more and less experienced readers may read the text “chorally,” or aloud at the same time.

When the more experienced reader guides the less experienced reader when the less experienced reader is reading aloud all or portions of the text region of story portion 12, the more experienced reader's objective may be to keep the less experienced reader from being frustrated if the less experienced reader cannot read, or has difficulty reading, a portion of the story. For example, if the less experienced reader has not been able to read aloud a word after a predetermined period of time, such as five seconds, then the more experienced reader may provide assistance. Illustrative, non-exclusive examples of techniques that may be utilized by the more experienced reader include assisting the less experienced reader to phonetically decode, or otherwise read aloud, difficult words, to skip a difficult word, to retry a difficult word, to retry a difficult word after reference to a corresponding graphics element of the story portion, to retry a difficult word after reference to the activity portion or the phonics skills presented therein, to take a break, etc. In addition, the more experienced reader may provide encouragement and/or praise to the less experienced reader as the less experienced reader reads, or attempts to read, the text region of a story portion aloud.

After completing the reading of the story portion, the more and less experienced readers may then discuss the story. As illustrative, non-exclusive examples, they may discuss whether they liked the story, whether it reminded them of events from their own lives or other stories, their favorite parts of the story, etc. This also may be an enrichment activity. This discussion not only facilitates the less experienced reader expressing feelings about the story and/or related topics, but because the story was phonetically correlated with the phonics skills presented in the activity portion, the discussion will likely result in additional use of the phonics skills by the less experienced reader.

The story portion may additionally or alternatively be reread, another story within the story portion may be read (when the story portion includes more than one story), or the readers may proceed to the enrichment portion (if present in a particular reading improvement device). Upon completion of the enrichment portion (if present and/or if desired), the more and less experienced readers may select another reading improvement device 10, which as discussed may be at the same or a different reading skill level. Because the devices are not “used up” after a single use, the reading improvement devices, including selected portions thereof, may be reused by the more and less experienced readers, as desired, and often with different results.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

Illustrative, non-exclusive examples of reading improvement devices and methods according to the present disclosure are presented in the following numbered paragraphs. It is within the scope of the present disclosure that the individual steps of the methods recited herein, including in the following numbered paragraphs, may additionally or alternatively be referred to as a “step for” performing the recited action.

1. A reading improvement device, comprising:

a pre-reading portion comprising a pre-reading phonics activity structured for collaborative completion by a more experienced reader and a less experienced reader; wherein the pre-reading phonics activity emphasizes a pre-reading phonetic element;

a story portion phonetically correlated with the phonics activity and including text with a plurality of the phonetic elements; and

at least one of an introduction portion and an enrichment portion; wherein, when present, the introduction portion includes instructions explaining collaborative use of the reading improvement device to improve the reading skills of the less experienced reader; and further wherein, when present, the enrichment portion includes a post-reading phonics activity structured for collaborative completion by the more experienced reader and the less experienced reader after collaborative reading of the story portion by the more experienced reader and the less experienced reader.

2. The reading improvement device of paragraph 1, wherein the pre-reading phonics activity of the pre-reading portion is designed for collaborative completion without writing on the pre-reading phonics activity by either of the more experienced reader or the less experienced reader.

3. The reading improvement device of any preceding paragraph, wherein the phonetic element is selected from the group consisting of graphemes, phonemes, and allographs.

4. The reading improvement device of any preceding paragraph, wherein the pre-reading portion emphasizes a plurality of phonetic elements.

5. The reading improvement device of paragraph 4, wherein the story portion includes graphics illustrating images of objects whose written spelling contains at least one of the plurality of phonetic elements.

6. The reading improvement device of any preceding paragraph, wherein the pre-reading phonics activity emphasizes a sight word to the less experienced reader.

7. The reading improvement device of paragraph 6, wherein the story portion includes graphics illustrating the sight word.

8. The reading improvement device of paragraph 6 or paragraph 7, wherein the phonics activity emphasizes a plurality of sight words to the less experienced reader.

9. The reading improvement device of any preceding paragraph, wherein the pre-reading portion includes a plurality of pre-reading phonetic activities.

10. The reading improvement device of any preceding paragraph, wherein the story portion includes a plurality of phonetically decodable words that are level-appropriate for the less experienced reader.

11. The reading improvement device of any preceding paragraph, wherein the pre-reading portion includes at least one pre-reading phonetic activity that introduces and emphasizes at least one sight word, and further wherein the story portion includes the at least one sight word.

12. The reading improvement device of paragraph 11, wherein the pre-reading activity portion includes at least one pre-reading phonetic activity that introduces and emphasizes a plurality of sight words, and further wherein the story portion includes the plurality of sight words.

13. The reading improvement device of any preceding paragraph, wherein the pre-reading activity portion emphasizes at least one phonetic element and at least one sight word to the less experienced reader.

14. The reading improvement device of paragraph 13, wherein the pre-reading activity portion emphasizes a plurality of phonetic elements and a plurality of sight words to the less experienced reader.

15. The reading improvement device of paragraph 13 or paragraph 14, wherein the story portion includes plural occurrences of the at least one phonetic element and the at least one sight word.

16. The reading improvement device of any preceding paragraph, wherein the reading improvement device includes the enrichment portion, and further wherein the post-reading activity of the enrichment portion is phonetically correlated with the story portion.

17. The reading improvement device of paragraph 16, wherein the post-reading activity of the enrichment portion is phonetically correlated with the story portion and the pre-reading phonics activity of the pre-reading portion.

18. The reading improvement device of paragraph 16 or paragraph 17, wherein the enrichment portion includes a plurality of post-reading activities.

19. The reading improvement device of any of paragraphs 16-18, wherein the pre-reading portion and the story portion have a reading skill level, and further wherein the post-reading activity has a reading skill level that is greater than the reading skill level of the pre-reading portion and the story portion.

20. The reading improvement device of any preceding paragraph, wherein the more experienced reader is a parent, and the less experienced reader is a child.

21. The reading improvement device of any preceding paragraph, wherein the reading improvement device is a book.

22. The reading improvement device of any of paragraphs 1-20, wherein the reading improvement device includes software.

23. The reading improvement device of any of paragraphs 1-20 and 22, wherein the reading improvement device is a computer-implemented device configured to generate a display of the pre-reading portion, the story portion, and when present, the introduction portion or the enrichment portion on a monitor.

24. A reading improvement kit comprising a plurality of the reading improvement devices of any of paragraphs 1-23.

25. The reading improvement kit of paragraph 24, wherein each of the plurality of reading improvement devices includes a reading skill level, wherein the plurality of reading improvement devices includes at least one reading improvement device having a first reading skill level, and at least one reading improvement device having a second reading skill level that is different than the first reading skill level.

26. The reading improvement kit of paragraph 25, wherein each of the plurality of reading improvement devices includes a level indicator indicating the reading skill level of the reading improvement device.

27. The reading improvement kit of paragraph 25 or paragraph 26, wherein the plurality of reading improvement devices includes at least a pair of reading improvement devices having the first reading skill level.

28. A method for improving reading skills, the method comprising:

collaboratively completing, by a more experienced reader and a less experienced reader, at least one pre-reading phonics activity from a reading improvement device, wherein the at least one pre-reading phonics activity is designed to emphasize at least one phonetic element to the less experienced reader; and

collaboratively reading a story portion of the reading improvement device, wherein the story portion includes a plurality of occurrences of the phonetic element.

29. The method of paragraph 28, wherein the method includes rereading the story portion.

30. The method of paragraph 29, wherein the rereading includes the less experienced reader reading a greater portion of the story portion than was read by the less experienced reader during the reading.

31. The method of any of paragraphs 28-30, wherein the at least one pre-reading phonics activity is designed to be completed without writing on the at least one pre-reading phonics activity, and wherein the method includes completing the at least one pre-reading phonics activity without writing on the at least one pre-reading phonics activity.

32. The method of any of paragraphs 28-31, wherein the method includes repeating the collaboratively completing.

33. The method of any of paragraphs 28-32, wherein the more experienced reader is a parent, and the less experienced reader is a child.

34. The method of any of paragraphs 28-33, wherein the method includes collaboratively completing by the more experienced reader and the less experienced reader at least one post-reading activity; and further wherein the at least one post-reading activity emphasizes at least one phonetic element.

35. The method of any of paragraphs 28-34, wherein the at least one post-reading activity is designed to be completed without writing on the at least one post-reading activity, and wherein the method includes completing the at least one post-reading activity without writing on the at least one post-reading activity.

36. The method of any of paragraphs 28-35, wherein the reading improvement device is a book.

37. The method of any of paragraphs 28-35, wherein the reading improvement device includes software.

38. The method of any of paragraphs 28-37, wherein the method includes selecting the reading improvement device from a plurality of reading improvement devices.

39. The use of any of the devices of paragraphs 1-27 to perform the methods of any of paragraphs 28-38.

40. A method of improving reading skills, comprising, collaboratively using, by a more experienced reader and a less experienced reader, the reading improvement device of any of paragraphs 1-27 to improve the less experienced reader's reading skills.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions, and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A reading improvement device, comprising:
a pre-reading portion comprising a pre-reading phonics activity structured for collaborative completion by a more experienced reader and a less experienced reader; wherein the pre-reading phonics activity emphasizes a pre-reading phonetic element;
a story portion phonetically correlated with the phonics activity and including text with a plurality of the phonetic elements; and
at least one of an introduction portion and an enrichment portion; wherein, when present, the introduction portion includes instructions explaining collaborative use of the reading improvement device to improve the reading skills of the less experienced reader; and further wherein, when present, the enrichment portion includes a post-reading phonics activity structured for collaborative completion by the more experienced reader and the less experienced reader after collaborative reading of the story portion by the more experienced reader and the less experienced reader.

2. The reading improvement device of claim 1, wherein the pre-reading phonics activity of the pre-reading portion is designed for collaborative completion without writing on the pre-reading phonics activity by either of the more experienced reader or the less experienced reader.

3. The reading improvement device of claim 1, wherein the phonetic element is selected from the group consisting of graphemes, phonemes, and allographs.

4. The reading improvement device of claim 1, wherein the pre-reading portion emphasizes a plurality of phonetic elements.

5. The reading improvement device of claim 4, wherein the story portion includes graphics illustrating images of objects whose written spelling contains at least one of the plurality of phonetic elements.

6. The reading improvement device of claim 1, wherein the pre-reading phonics activity emphasizes a sight word to the less experienced reader, and further wherein the story portion includes graphics illustrating the sight word.

7. The reading improvement device of claim 1, wherein the pre-reading portion includes a plurality of pre-reading phonetic activities.

8. The reading improvement device of claim 1, wherein the story portion includes a plurality of phonetically decodable words that are level-appropriate for the less experienced reader.

9. The reading improvement device of claim 1, wherein the reading improvement device includes an enrichment portion, and further wherein the post-reading activity of the enrichment portion is phonetically correlated with the story portion.

10. The reading improvement device of claim 9, wherein the pre-reading portion and the story portion have a reading skill level, and further wherein the post-reading activity has a reading skill level that is greater than the reading skill level of the pre-reading portion and the story portion.

11. The reading improvement device of claim 1, wherein the reading improvement device is a book.

12. The reading improvement device of claim 1, wherein the reading improvement device includes software.

13. The reading improvement device of claim 1, wherein the reading improvement device is a computer-implemented device configured to generate a display of the pre-reading portion, the story portion, and when present, the introduction portion or the enrichment portion on a monitor.

14. A reading improvement kit comprising a plurality of the reading improvement devices of claim 1.

15. The reading improvement kit of claim 14, wherein each of the plurality of reading improvement devices includes a reading skill level, wherein the plurality of reading improvement devices includes at least one reading improvement device having a first reading skill level, and at least one reading improvement device having a second reading skill level that is different than the first reading skill level.

16. The reading improvement kit of claim 15, wherein each of the plurality of reading improvement devices includes a level indicator indicating the reading skill level of the reading improvement device.

17. A method for improving reading skills, the method comprising:
collaboratively completing, by a more experienced reader and a less experienced reader, at least one pre-reading phonics activity from a reading improvement device, wherein the at least one pre-reading phonics activity is designed to emphasize at least one phonetic element to the less experienced reader; and
collaboratively reading a story portion of the reading improvement device, wherein the story portion includes a plurality of occurrences of the phonetic element.

18. The method of claim 17, wherein the method includes rereading the story portion.

19. The method of claim 18, wherein the rereading includes the less experienced reader reading a greater portion of the story portion than was read by the less experienced reader during the reading.

20. The method of claim 17, wherein the at least one pre-reading phonics activity is designed to be completed without writing on the at least one pre-reading phonics activity, and wherein the method includes completing the at least one pre-reading phonics activity without writing on the at least one pre-reading phonics activity.

21. The method of claim 17, wherein the method includes collaboratively completing by the more experienced reader and the less experienced reader at least one post-reading activity; and further wherein the at least one post-reading activity emphasizes at least one phonetic element.

22. The method of claim 17, wherein the at least one post-reading activity is designed to be completed without writing on the at least one post-reading activity, and wherein the method includes completing the at least one post-reading activity without writing on the at least one post-reading activity.

23. The method of claim 17, wherein the method includes selecting the reading improvement device from a plurality of reading improvement devices.

24. A method of improving reading skills, comprising, collaboratively using, by a more experienced reader and a less experienced reader, the reading improvement device of claim 1 to improve the less experienced reader's reading skills.
